(19) United States
(12) Patent Application Publication
(10) Pub. No.: US 2010/0064919 A1
(43) Pub. Date: Mar. 18, 2010

(54) Device for Cleaning a Printing Cylinder

(75) Inventor: Richard Grieger, Hafenlohr (DE)

Correspondence Address: HOOKER & HABIB, P.C., 100 CHESTNUT STREET, SUITE 304, HARRISBURG, PA, 17101, US

(73) Assignee: INNOWATEC DIPL-ING. GRIEGER & ENGLERT GMBH & CO. KG, Hafenlohr (DE)

(21) Appl. No.: 12/444,483

(22) PCT Filed: Oct. 8, 2007
(86) PCT No.: PCT/EP07/08708

§ 371 Date: Apr. 30, 2009

(30) Foreign Application Priority Data
Oct. 9, 2006 (DE) 20 2006 015 429.9

(51) Int. Cl. B41F 35/00

(52) U.S. Cl. 101/425

(57) ABSTRACT

The invention relates to a cleaning device (4) for cleaning a printing cylinder (2), said device comprising a driven rotary brush (12) having a rotational axis (16) parallel to the rotational axis of the printing cylinder (2) and comprising a brush arrangement (28; 28a-d) mounted on a drive shaft (30). Said brush arrangement (28; 28a-d) comprises a plurality of sleeve-type brush elements (28a-d) which are axially arranged one after the other. The invention also relates to a corresponding cleaning device (4) comprising a carrier element (6) extending parallel to the drive shaft (30) and provided with at least one channel arrangement (38a, b; 40a, b) extending in the axial direction and used to distribute and/or dispense a cleaning medium. The carrier element (6) is embodied, as a single component, as an extruded section comprising the channel arrangement (38a, b; 40a, b).

The invention concerns a device for cleaning a printing cylinder, wherein said device has a driven rotational, brush cylinder, the longitudinal axle thereof being parallel to the axle of the printing cylinder and which brush cylinder consists of cylindrical brush elements successively arranged on a drive shaft.

Cleaning devices of this description or similar thereto become necessary adjuncts to printing machines in order to wash away color remnants, paper particulate or like contaminating material from the printing cylinders. These devices can also be employed on other cylinders of a printing machine, wherein the cylinders contact printing materials, and residuals thereof must be removed. As a rule, today, printing machines are equipped with similar cleaning devices.

In a conventional manner, brush cylinders are employed as the cleaning agent for a printing cylinder surface. The brush cylinders lie parallel to the printing cylinder to be cleaned and can be moved against the printing cylinder or can be separated therefrom by an adjustment apparatus. In order to improve the cleaning effect, the brush cylinder, i.e., the rotational brush, is driven in a rotation counter to that of the printing cylinder. Hydraulic, pneumatic or electric motors serve for the driving action.

The rotational brush cleans during the operation of the printing machine, that is to say, while printing is operation, and rotates against the printing cylinder surface. As this is in progress superfluous printing color remnants or unwanted residuals transferred to the rotational brush receive rinsing by a wash medium and are removed from the rotational brush as described below. (In the following, the term “wash medium” is to embrace a fluid detergent and/or water.) The waste which has entrained itself in the washing medium is removed from the rotational brush by a doctor blade and is collected in a trough underneath the rotational brush.

Within the circulation system which provides wash fluid, delivery nozzles are furnished as components of the cleaning device. These delivery nozzles supply wash fluid to open-slit spraying apparatuses. Cleaning devices utilizing components of this nature have been disclosed by WO2005/082626.

In an alternate design, cleaning devices exist, which operate with a washing cloth. This cloth is so placed as to contact the surface of the cylinder to be cleaned and remove the contaminant therefrom. A supplying arrangement coacts with an on-and-off winder to displace the washing cloth and thus continually renew that portion of the cloth which had already contacted cylinder being cleaned. This operative principle is subjective to considerable maintenance time, since the entire wash cloth must be frequently replaced. Moreover, a required cloth roll-up system is heavy, with the result that—especially in the case of larger printing machines—such cleaning systems do not receive necessary maintenance or the systems may be disadvantageously removed.

In the case of known cleaning devices, required wash medium supply and distribution tubes must be installed in order to supply and distribute cleaning fluid. Additionally, time must be spent for mounting and exact adjustment of holding mechanisms for protective covers and/or for doctor blades.

An additional problem with presently disclosed cleaning devices is that the accumulation of contaminant randomly extends its intensity beyond the axial length of the printing cylinders. Where known revolving brushes are involved, it is possible that currently installed brush cylinders are caused to bend in accord with the operative pressure. This pressure is exerted along the longitudinal axis of the cylinders and develops transversely directed components. Accordingly, the washing operation becomes irregular. That is to say, the efficiency of the brush cylinders is diminished.

A primary purpose of the present invention is to be found therein, in that these cited disadvantages are to be set aside or, at least, to be lessened in their effect.

One advantage is that a superior brush cylinder is made available which, in consideration of its cleaning and low maintenance characteristics, is substantially improved.

Yet another advantage arises, in that the construction of the cleaning device is simplified and simultaneously, a better supply and distribution of washing medium has been realized. The time consuming procurement of extraneous construction elements for the washing device is reduced.

The above purpose as well as the said advantages are achieved by the object of claim 1. The invention is particularly advantageous, in that the brush assembly comprises a plurality of cartridge shaped, cylindrical brush elements, which are axially linked in end-to-end engagements. The cleaning body of the rotational brush cylinder is thus formed by individual, cartridge-like elements, the number of which can be varied within the axial length of a brush cylinder. This advantage with standard individual cartridges permits the installation of different brush cartridges of varied lengths. The flexibility of types of production is increased and a reduction in time and maintenance is achieved. Should, during operation, one length of brushes exhibit excessive wear, it is no longer necessary to replace an entire rotational brush cylinder. Only specific elements showing wear need be renewed.

The developments in accord with claims 2 and 3 increase this flexibility. Claim 2 states that the arrangements of brushes allows a multiplicity of different brush elements. The different brush elements can consist of various materials or of combinations thereof. The brush elements can even possess different geometric shapes.

In accord with claim 3, brush elements can be used which possess different axial lengths and/or possess a variance of bristle characteristics. In one case, for instance, the brush cylinder itself can be made to desirable, exact lengths, this being done by combining elements of different lengths. As another alternate, the cleaning characteristics of the brush arrangement can be varied within sectional lengths of the contacted printing cylinder. Thereby the cleaning operation is improved and the duration of the cleaning operation is reduced. In this way expensive waste of trial run paper strip can be diminished. For example, in the region of the edge zone of the paper strip, at which location an increased buildup of paper particulate accumulates on the printing cylinder, brushes of a harder nature can be installed, whereby in this zone the cleaning will be of greater intensity. Simultaneously, in the middle zone of the axial brush series, softer brushes can be inserted so that an axially distributed load is lessened. Thus, an individual bending deflection of the rotational brush is prevented or reduced. This has an advantageous effect on the bending stress on the drive shaft. The characteristics of the bristles can be advantageously altered by means of adjusting their length, rigidity, or combined surface shape.

The improvements of the invented cleaning device, in accord with claims 4 to 7, concern the arrangements of brush elements on their coaxial drive shaft.

In accord with claim 4, the ends of the brush elements, which confront each other are so constructed, that they turnably interlocked themselves. This fabrication eases the assembly as well as the disassembly of the elements. For a turnable fixation with the drive shaft, it is sufficient if only one, individual brush element is coupled thereto. With this arrangement, turning movement is transmitted from the so coupled element through the said end faces of the remaining successive brush elements.

Claim 5 states that the above end faces are profiled with toothing, which forms a complementary, mutual engagement of one end face to the next. That is to say, the toothed end face surfaces of one brush element locks precisely into the toothed end face surface of the immediately neighboring brush element.

Claim 6 discloses that the toothed elements carry (at least) one bristle bundle. This prevents any gap to be created between individual brush elements, wherein no cleaning action could be carried out.

In accord with claim 7, one brush element at the end of the brush assembly is turnably and axially affixed to the drive shaft. This so affixed element transfers the rotational movement of the drive shaft to the other brush elements by means of the above described toothed end face. With such an arrangement, only one brush element need be so anchored to the drive shaft, which allows the other brush elements to be simply slipped onto the drive shaft against an axial end detent. In this way the maintenance, mounting and disassembly can be carried out from a free end of the rotational brush cylinder.

Claim 8 states an improvement which allows an additional betterment of the cleaning apparatus in regard to supply of washing medium and connection of components. The provision of a carrier member running parallel to the drive shaft is stated, which carrier member possesses at least one conduit system running in an axial direction, which system is used for the supply and distribution of a cleaning fluid. The said carrier member is pressure cast in one-piece and integrally contains the said conduit system.

Because the carrier member incorporates the entire washing apparatus and the thereto belonging components and the integrated conduit system acts for the distribution and discharge of the wash medium, the conventional provision of extraneous nozzle tubes, their installation and complicated connection arrangements can be done away with.

Additional developments are brought forward by claim 9, wherein a grooved shape is provided to retain and guide slidable attachments, which can be fixed in place for proper adjustment. On the carrier member can also be mounted added components, such as a stripper, a doctor blades, and protective coverings. Placement in the profiled, sliding groove of operational attachments eases the adjustment and regulation of the said added components.

Claim 10 discloses a first conduit arrangement, wherein is to be found a distribution system and a tubular delivery arrangement running parallel thereto, which latter serves to form a more extended distribution and circulation of the wash medium.

The distribution and the delivery circulation systems are bound together by a plurality of interconnecting tubular passages. The presence of one distributor conduit and one delivery conduit assures that the wash medium remains at a constant pressure at the delivery nozzles so that that the entire length of the printing cylinder is uniformly wetted with wash medium.

Claim 11 defines a second, characteristically designed conduit arrangement for the supply of wash medium.

Where wash medium is being applied for cleaning, claim 12 declares that the fluid delivery openings are bored to fit self-sealing delivery nozzles made of an appropriate elastic material. With this advantage, it is possible for nozzles to be inserted directly into the delivery openings without additional adherent or fastening means.

Claim 13 states that characteristic delivery nozzles include an adaption piece, which is complementary to the wash medium outlet opening and by means of which, the said opening becomes equipped with an appropriate delivery nozzle. These adaption pieces open within a distribution segment which runs in an axial direction and is U-form in shape. In this way, a delivery nozzle uniformly washes, first the rotational brush cylinder and the printing cylinder and second the said U-shaped distribution segment prevents the wash medium from concentrating itself in such areas of the cleaning device wherein a cleaning action has no purpose. This action additionally improves the cleaning operation and the available cleaning solution is more effectively put to use.

The structural development as stated in claim 14 provides an especially favorable application direction of the wash medium. Claim 14 also discloses, that the device for the cleaning of a printing cylinder is also provided with a drive assembly for the turning of the rotational brush, a water supply arrangement, a wash medium system, a metal covering for protection, and a doctor blade. An apparatus of such a description can be retrofit into an existing printing machine as a complete, compact unit.

Claim 16 concerns a printing machine with an invented device for cleaning a printing cylinder as set forth in the description.

One operational version of the present invention is described in greater detail in the following with the aid of attached drawings. There is shown in:

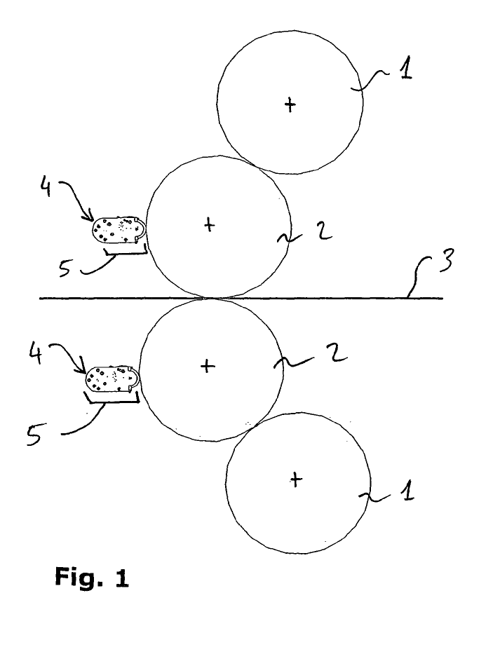

FIG. 1 a schematic view of a printing machine with two devices for the cleaning of a printing cylinder

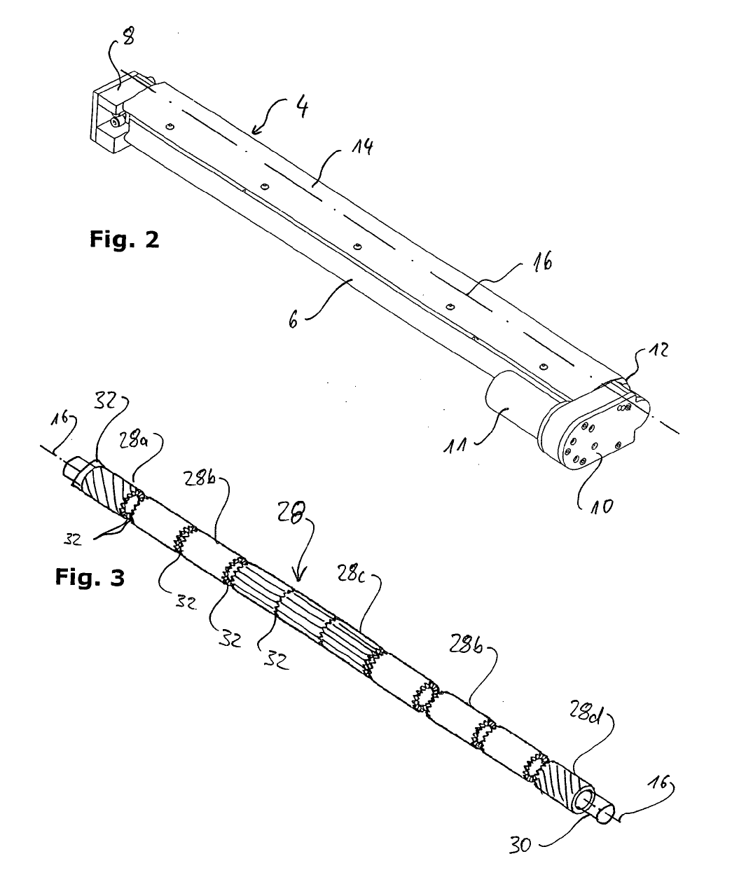

FIG. 2 a perspective view of a device for cleaning a printing cylinder as seen angularly from above,

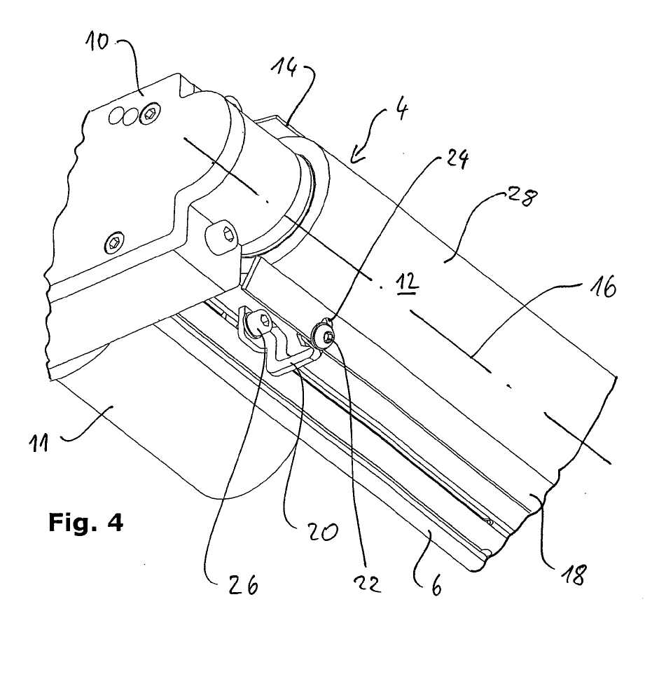

FIG. 3 a perspective view of a rotational brush assembly having a plurality of cartridge-like brush elements,

FIG. 4 a perspective view of a detailed segment of the cleaning device of FIG. 2, as seen angularly from below,

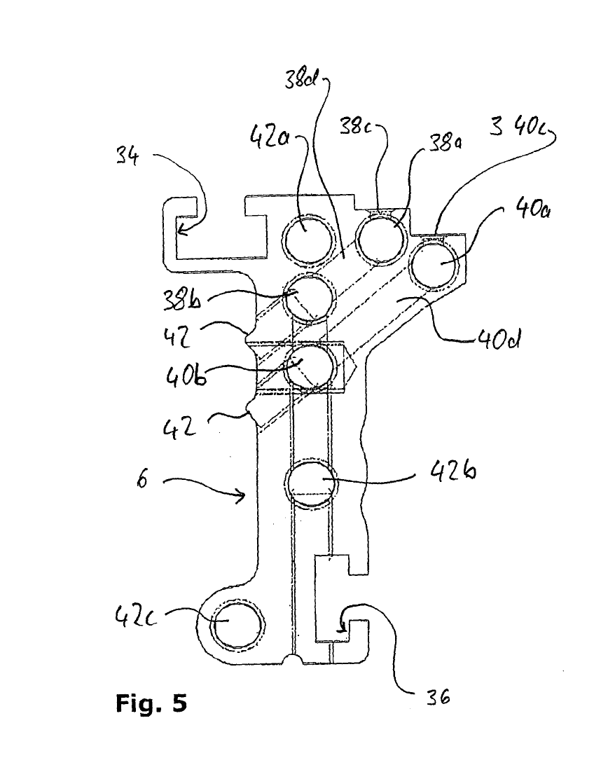

FIG. 5 a view showing the end-face of a carrier member comprised of an extruded structural shape for the cleaning device shown in FIGS. 1, 2 and 4,

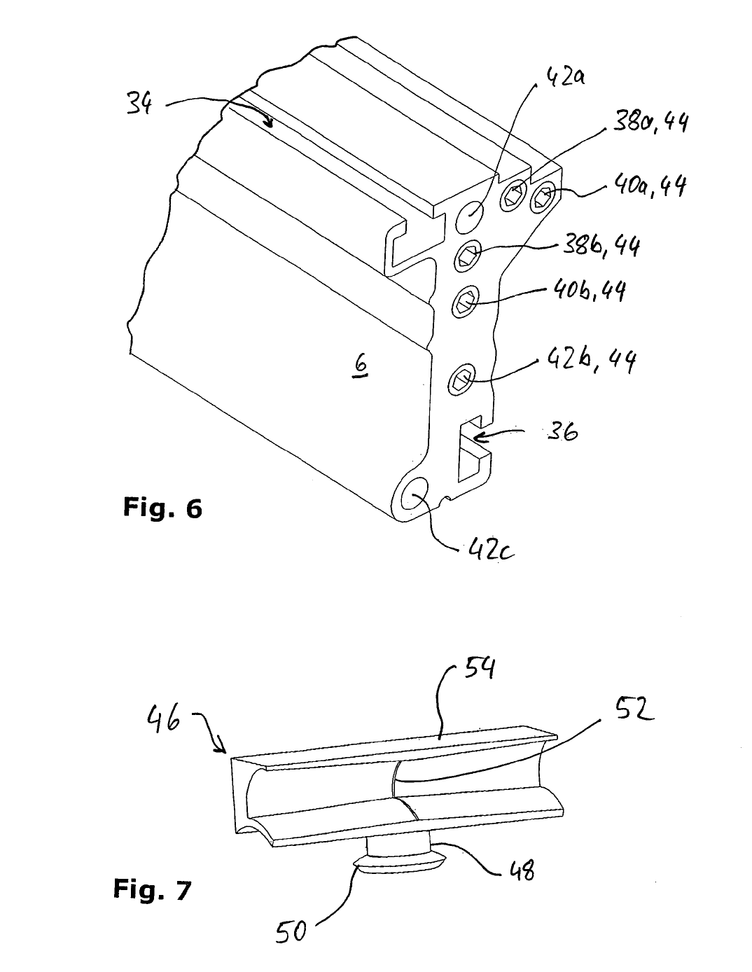

FIG. 6 a perspective view of a part of the carrier member shown in FIG. 5 and

FIG. 7 a delivery nozzle for connection to the carrier member shown in FIGS. 5, 6.

FIG. 1 shows, schematically, a section from an offset printing machine intended for the two-sided printing of a continuously running paper strip 3. In the presentation are two imaging cylinders 1, which impart images to be printed onto respective printing cylinders 2. This arrangement allows for the printing of the paper strip 3 on both sides, this being represented in the drawing by an upper and a lower positioning of the respective cylinders. Placed in contact with the printing cylinder 2 are shown devices 4 for cleaning. These devices 4, by means of a (not shown) positioning mechanism, can be caused to be in contact with or to be separated from the printing cylinder 2. The devices 4 clean the printing cylinder with the aid of a wash medium, which, for instance, might be advisable following a change of printing plates. During, or after such cleaning, the wash medium is stripped off into receiving troughs 5. From the receiving troughs 5, the now used medium can be discarded or conducted to a (not shown) recycling system.

The perspective presentation of FIG. 2 shows in greater detail the device for cleaning a printing cylinder 4, wherein included is a carrier member 6, which, in its installed position extends itself parallel to the rotational axis of the printing cylinder 2. At the ends of the carrier member 6 is located a bearing 8 and, oppositely situated, can be seen a drive unit 10. The drive unit 10 is actuated by a motor 11.

Between the bearing unit 8 and the drive unit 10 extends a rotational brush 12, which, in FIG. 2, is situated under a cover 14 attached to carrier member 6. The rotational brush 12 turns about its longitudinal axis 16 which runs between the bearing unit 8 and the drive unit 10.

The drive unit 10, which rotates the brush 12, is comprised of a driving mechanism, which is powered by means of the motor 11. The axis of rotation 16 extends itself, in the installed condition, parallel to the rotational axis of the printing cylinder 2 which is to undergo cleaning.

FIG. 4 provides further detail by a perspective view from below of a portion of the drive side end of the device for cleaning a printing cylinder 4. Underneath the rotational brush 12 is placed a doctor blade 18, which is secured by a holding means 20 and a screw 22. The screw 22 is slidably placed in a lengthened slot 24, so that it can be adjusted in a direction transverse to the axis of rotation 16. The holding element 20 is secured by an adjustable T-screw 26, which protrudes itself into a slide groove 34. The groove 34 runs along the carrier member 6, parallel to the rotational axis 16.

The rotational brush 12 is mounted coaxially with drive shaft 30 which shaft runs from the drive unit 10 to the bearing 8. This drive shaft 30 is comprised of a carbon fiber reinforced tube to save weight. Brush arrangement 28, accordingly, is turn-fast, coaxially mounted on the drive shaft 30. The brush arrangement 28 is obliged to rotate about a axis of rotation 16 common to the drive shaft 30. Drive shaft 30 is rotated by means of motor 11 working through drive unit 10. Simultaneously, brush bristle ends are freed by the doctor blade 18 from a mixture of, for example, cleaning medium, dirt and residue of printing color.

The construction of the brush arrangement 28 is shown in FIG. 3 in greater detail. The brush arrangement 28 is assembled from a series of brush elements, namely 28a, 28b, 28c, 28d. These brush elements 28a-d are in cartridge form and possess on their circumferential surface radially extending bristles. The cartridge material can be plastic, metal, or another appropriate material, which must be of a character to allow the insertion and the affixing of the said bristles. The brush elements 28a-d are placed on the central drive shaft 30 in a coaxial manner. For clarification purposes, in FIG. 3 some of the brush elements 28a-d are shown as separated one from another. In a ready-to-run assembly, all brush element 28a-d are engaged tightly together on the said drive shaft 30.

On the bearing end of the brush arrangement 28, in the presented exemplary version, a bonding means 32 is provided, against which the end brush element 28a of the axial arrangement 28 abuts. At its oppositely situated end surface, brush element 28a has a toothed face 33, which engages itself into a complementary toothed face 32 of the immediately neighboring brush element 28b. All other brush elements, 28b, 28c, 28d likewise meet complementary toothed end faces 32 into which they engage. The drive end brush element 28d, in this arrangement, is turn-fast affixed to the drive shaft 30. Upon the rotation of the drive shaft 30, this turn-fast connection between the drive shaft 30 and the brush element 28d picks up the turning torque directly, transmitting this to the other brush elements 28a-c through the described end face toothing 32.

The turn-fast fixation between the brush element 28d and the drive shaft 30 can be accomplished by shape or force fit. For these types of connections, appropriate cross-sectional attachments or binding means can be provided. The brush element 28d is likewise placed in an axial direction against the neighboring element 28b. Alternately to the above, this can also be carried out by a clamping binder (not shown) on the drive shaft 30 or by another appropriate connecting means.

This version of the brush arrangement 28 permits the realization of rotating brushes 12 of different lengths, wherein a plurality of brush elements 28a-d can be linearly combined to make up a desired length.

The brush elements 28a-d in the presented examples are provided with different bristles, which are represented in FIG. 3 by cross-hatching or the absence thereof. In this way, the brush elements 28a and 28d, which, respectively are provided at the ends of the brush arrangement 28, are equipped with hard bristles. With that arrangement of bristles, it is possible that these stated brush elements can clean the printing cylinder 2 more effectively in the zone of the paper strip edges. The brush elements 28c and 28d, which lie therebetween, can have softer bristles, since in this middle area the contamination intensity is generally not so severe. Consequently then, the brush elements 28c can possess especially soft bristles. The axial, linear stress, which acts upon the brush elements 28a to 28d in their place on the drive shaft 30, can, by this bristle arrangement, be reduced in the middle zone. Thereby, the bending stress, especially in the middle zone of the drive shaft 30 is diminished and the cleaning intensity is correspondingly increased. In other words, the usefulness of the brush elements 28a-d has been increased. The brush elements 28a-d can be designed to be different in their axial length. Accordingly then, in the edge areas—thus in the paper strip edge zones—a narrow brush element 28a or 28d would be found to be sufficient, while at the same time the intervening brush elements 28b, 29c can be designed with longer axial lengths.

In another (not shown) version, the possibility exists, that the brush elements 28b, 28c located in the middle zone can be replaced by a single brush element. In this way, the bending stress of the drive shaft 30 would be further reduced, since a centrally placed, continuous brush element increases resistance to bending by a considerable amount.

As to the FIGS. 5, 6, the construction and the function of the carrier member 6 is defined. The carrier member 6 consists of an aluminum alloy or a another material capable of being subjected to extrusion molding to form a one piece structural member. As the carrier is being extruded, the complete external contour including two sliding groove tracks 34, 36 and several conduits, namely 38a, 39b, 40a, 40b and 42a, b and c are in simultaneous formation.

The conduit pairs 38a, 38b and 40a, 40b lie in two parallel planes. The conduits 38a, 38b and 40a and 40b serve for the supply of wash medium. The conduits 38a and 38b are intended for the supply of washing medium and the conduits 40a and 40b serve for the transport of water. The conduits 38a and 40a are designed as delivery conduits and accordingly exhibit a plurality of respective delivery openings 38c, 40c which open to the outside. The delivery conduits 38a and 40a are in communication with the distribution conduits 38b, 40b by means of diagonal borings 38d and 40d. The borings 38d and 40d are equipped at the open ends with respective plugs 42, which are installed in a subsequent machining operation which includes boring and milling. Openings to the outside is closed by means of appropriate plugging, so that only the connecting borings between the conduits 38a and 38b as well as between 40a and 40b remain open.

The distribution conduits 38b and 40b deliver wash medium and/or water. By means of interconnection lines 38d and 40d this medium and water flow is uniformly divided into the delivery conduits 38a and 40a, so that at the discharge openings 38c and 40c, predominately identical pressure and flow conditions exist.

The number of the discharge openings 38c and 40c as well as interconnection conduits 38d and 40d depend on the length of the carrier member 6, which length corresponds, approximately, to the length of the printing cylinder 2 which is to be cleaned.

Borings for conduits 42a, 42b, 42c, allow threaded inserts to be provided on their terminations at respective carrier end faces This plugging permits the installation of the bearing 8 and the drive unit 10. The conduits 42a, 42b, 42c also provide thereby an abutment for the attachment means of the said bearing 8 and the drive unit 10.

Wash medium can be introduced into the distribution conduits 38b, 40b either from the ends or the sides thereof through appropriate borings. Openings, which are not being put to use (either on the ends or the sides) are closed off by means of threaded plugs 44. This is made evident in FIG. 6.

The slotted guides 34 and 36 also perform as sliding runways, in which T-nut assemblies can be linearly positioned and be fixed in place. These T-nuts serve here, first for positioning of the holding element 20 for the doctor blade 18 and secondly for the securement of the corresponding set screws of the protective cover 14.

The discharge openings 38c and 48c permit the insertion of delivery nozzles 46, from which wash medium or water is apportioned to the printing cylinders 2 by spraying and directional deflecting.

FIG. 7 exhibits such a delivery nozzle 46. The delivery nozzle 46 consists of a relatively soft, elastic material (for example: soft PVC, silicone, or an appropriate elastomer). On its lower end in FIG. 7, the delivery nozzle 46 possesses a connection piece 48 whereby a sealing collar 50 is placed at the lower end thereof. These connection pieces 48, together with their attached sealing collars 50, are flexibly inserted into the discharge openings 38c and 40c. Upon being subjected to pressure, the collar 50 seals each inside circumference of the discharge openings 38c, 40c from the ambient surroundings.

A passage is located in the interior of the connection piece 48, which bind the discharge openings 38a, 40a with a slit shaped dispensing nozzle 52, through which the wash medium is ejected.

The dispensing nozzle slit 52 bisects a U-shaped distributor 54, which extends itself parallel to the carrier member 6. This distributor 54 directs the flow of the wash medium as required onto the rotational brush 12 as well as onto the printing cylinder 2. In FIG. 5 the open side of the U-shaped distributor 54 faces to the right and the longitudinal direction of the distributor 54 runs figuratively perpendicular to the paper on which it is drawn. The above described formulation of the dispensing nozzle assures an optimal usage of the rotational brush 12 and therewith an improved employment of the applied wash medium. During a cleaning operation, the special design of the delivery nozzles 46, wherein they are in a stepwise succession on the carrier member 6, permits the cleaning application of more than one type of wash medium to be used against the rotational brushes 12, successively or, if desired, in a predetermined mixture. Accordingly, an ideally conceived wash medium becomes available for cleaning the said rotational brushes 12 as well as for application onto the printing cylinder 2.

The carrier member in the here presented version, in company with the arrangement of the brushes, can also be used with a conventional brush or cleaning design. The presented brush assembly can also be retrofit into conventionally constructed cleaning apparatuses.

Further deviations and formulations within the framework of the present patent claims are allowable for the expert.

1. A device (4) for cleaning a printing cylinder (2) with a driven rotational brush (12), the axis of rotation (16) of which lies parallel to the axis of rotation of the printing cylinder (2) and which possesses a specially assembled brush arrangement (28) on a drive shaft (30), whereby the brush arrangement (28) is comprised of a plurality of axially aligned cartridge shaped brush elements (28a, b, c, d).

2. A device (4), in accord with claim 1, wherein the brush arrangement (28) possesses a plurality of different brush elements (28a, b, c, d).

3. A device (4), in accord with claim 2, wherein the brush elements (28a, b, c, d) exhibit axial lengths of different lengths and/or bristles of different characteristics.

4. A device (4) in accord with claim 1, wherein the confronting face elements of the brush elements (28a, b, c, d) are so designed, that they can couple with one another in fixed rotation.

5. A device (4) in accord with claim 4, wherein the face to face ends of the brush elements (28a, b, c, d) possess toothing which is mutually complementary.

6. A device (4) in accord with claim 5, characterized therein, in that the elements (32a) of the end face toothing (32) possess respectively, a bristle bundle.

7. A device (4) in accord with claim 1, wherein a brush element (28a, d) located at the end of the brush arrangement (28) is rotationally and axially affixed to the concentric drive shaft (30).

8. A device (4) in accord with claim 1, having a carrier member (6) extending itself parallel to the drive shaft (30), which carrier member (6) possesses at least one conduit system (38a, b; 40a, b), which runs in an axial direction for the distribution and/or the delivery of cleaning medium, whereby the carrier member (6), which is extruded as one piece, encompasses the said conduit system (38a, b; 40a, b).

9. A device (4) in accord with claim 8, wherein the carrier member (6) possesses a profiled groove (34, 36) for the accommodation and affixing of slidable, stationarily adjustable holding elements (20), onto which attached units (14, 18) may be installed.

10. A device (4) in accord with claim 8, wherein a first conduit system (38a, b) comprises parallel conduits for, respectively, delivery and distribution of wash medium, whereby the said conduits (38a, b) are in communication with a plurality of interconnecting borings (38d) and the delivery conduit (38a) possesses a multitude of delivery openings (38c).

11. A device (4) in accord with claim 8, wherein a second conduit system (40a, b) comprises parallel conduits for, respectively, delivery and distribution of wash medium, whereby the said conduits (40a, b) are in communication with a plurality of interconnecting borings (40d) and the delivery conduit (40a) possesses a multitude of delivery openings (40c).

12. A device (4) in accord with claim 10, wherein the delivery openings (38c, 40c) are inserted with self sealing, delivery nozzles (46), which are made of elastic material.

13. A device (4) in accord with claim 12, wherein the delivery nozzles (46) possess complementary connections (48, 50) into which the delivery opening (38c, 40c) discharges and wherein said connections (48, 50) connect with a slit (52), which is placed in a U-shaped distributor (54) running in an axial direction.

14. A device (4) in accord with claim 13, wherein the open side of a distributor (54) is exposed at an approximate right angle to the discharge opening (38c, 40c).

15. A device (4) in accord with claim 1 which additionally possesses a drive and motor, respectively (10, 11) for the turning of rotation brush (12), separate supply systems for water and wash medium, a cover (14) and a doctor blade (18).

16. A printing machine with a device (4) for the cleaning of a printing cylinder in accord with claim 1.

17. A device (4) in accord with claim 8 which additionally possesses a drive and motor respectively (10, 11) for the turning of rotation brush (12), separate supply systems for water and wash medium, a cover (14) and a doctor blade (18).

18. A printing machine with a device (4) for the cleaning of a printing cylinder in accord with claim 8.
